(19) United States
(12) Patent Application Publication
(10) Pub. No.: US 2023/0051896 A1
(43) Pub. Date: Feb. 16, 2023

(54) STEERING TO MITIGATE STRANDED CLIENTS IN MESH NETWORKS

(71) Applicant: ARRIS Enterprises LLC, Suwanee, GA (US)

(72) Inventors: Jay STRATER, San Diego, CA (US); Diwya Kandagath MOHANAN, Bangalore (IN); Chethan Alur GURUMALLAPPA, Bengaluru (IN); Paul BAKER, San Diego, CA (US); Gregory NAKANISHI, San Diego, CA (US)

(21) Appl. No.: 17/746,024

(22) Filed: May 17, 2022

Related U.S. Application Data
(60) Provisional application No. 63/232,307, filed on Aug. 12, 2021.

(51) Int. Cl. H04W 72/12; H04W 24/02

(52) U.S. Cl. CPC H04W 72/1231; H04W 24/02; H04W 84/18

(57) ABSTRACT

To prevent a client device from being stranded, a steering controller of an access point device can provide an improved network environment or performance by steering a target client device to a basic service set (BSS) of a network device that is different from the current BSS of the target client device based on a first or a poor link quality threshold where non-associated client (NAC) link quality parameters for NAC network devices within the network environment, such as a mesh network, is not available. The steering controller can select or identify a candidate BSS and then send a steering query to the target client device. The steering controller can receive a response from the target client device that indicates whether the steering to the candidate BSS was successful or accepted by the targeted client device.

### BACKGROUND

Many network environments include multiple network devices, such as a gateway, an access point, an extender, various client devices, etc. For example, a network environment can be a mesh network where various network devices act as a single wireless fidelity (Wi-Fi) network. Generally, a wi-fi network with a mesh service contains a network device (such as a gateway) and one or more wireless extender devices. A controller typically resides in the gateway and is involved in discovery and configuration of the gateway and extender device's radio access points of a basic service set (BSS) that can be associated with an extended service set (ESS). An ESS shares a service set identifier (SSID) encryption type and preshared key (PSK) with the BSS. The controller is also typically involved in determining if a client device or client station which is associated on the BSS should be moved and/or steered to another BSS and, if so, executing the client steer.

Several conditions can reactively prompt a controller to determine that a client device or client station (STA) should be or needs to be steered. The conditions can comprise poor link quality (such as low received signal strength indicator (RSSI), received channel power indicator (RCPI), or physical layer (PHY) rate) with the associated BSS, high front-haul (FH) channel utilization on the associated BSS, and high link utilization from the back-haul (BH) to the BH-BSS of the upstream device. In addition, the controller can proactively try to steer a client device or client station for radio band purposes from a first association (for example, a 2.4 gigahertz (GHz) radio BSS association) to a second association (for example, a 5 GHz radio BSS association or a 6 GHz radio BSS association) if the controller determines that the client device or client station is better served by the second association based on the conditions (such as link quality or utilization issues). Typically, a controller needs certain expected network data, for example, about the expected RSSI or related RCPI that a client device will encounter if steered to another BSS (referred to as non-associated client (NAC) data, to determine whether to attempt to steer a client device (or station) to another BSS. If this expected network data is lacking or inaccurate then a client device will typically not be moved, but if this expected network data is available and reasonably accurate a client device may be steered. However, such network data (NAC data) may not be available for one or more network devices resulting in a client device being stranded or rather connected to a non-optimal or inoperable BSS association.

Obtaining timely and accurate network information (NAC data) can be very challenging. For example, Scenario 1) NAC data can be gathered by the controller from other BSS radios in the network that receive timely frames (such as within thirty seconds) from the target client device (or station), however, such information is generally available and accurate from another device BSS if sharing the same channel (such as a 5 gigahertz (GHz) radio on a dual-band extender sharing 5 GHz front and backhaul channel with a dual band gateway 5 GHz radio) but can be lacking on other scenarios that require off-channel scanning where limited scan time is available and when client device traffic is limited to management traffic or probes (such as when a client device is on a 2.4 GHz channel 1 and no overlapping network device in the area is using 2.4 GHz channel 1, then the client device could be stranded on the poor connection even though stronger or better network performance connections are available); Scenario 2) NAC data can be requested directly from a client device via a IEEE 802.11k beacon report request, however, such can be limited because of the lack of beacon report support or reporting errors by the client device and can be intrusive as a beacon report requests requires an active client device to off-channel scan one or more BSS beacon network parameters for NAC data; and Scenario 3) the NAC data can be estimated from the current association, however, such applies to the other band on the same client device which can have estimated accuracy issues. Generally, then Scenario 3 is used for band-steering a client device between bands on the same device, Scenario 1 occurs for gateway or access point steering a client device via a 5 GHz channel between gateway(s)/access point(s) sharing a channel, and Scenario 2 is not prevalently supported or properly implemented when Scenario 1 does not occur. These scenarios can cause client devices that are not moved or steered, for example, from a 2.4 GHz radio to a 5 GHz radio on the client device to be “stranded” on a weak 2.4 GHz radio as the client device moves around a site. Thus, there is a need to provide steering for client devices where certain network data or information (NAC data, such as one or more NAC link quality parameters) is not available or does not meet a threshold so as to provide an improved network performance or network environment for the client devices.

### SUMMARY

According to some aspects of the present disclosure there are provided novel solutions for steering a target client device within a Wi-Fi mesh network so as to mitigate stranded client devices to provide an improved network environment. A steering controller within a network environment, such as a mesh network, can still provide select steering of a client device associated with a network device (such as an access point device and/or one or more extender access point devices) to a different network device when no data is able to be collected from one or more BSS on each non-associated client network devices for the client device. For example, the steering controller can attempt to steer the client device to a candidate BSS on another network device and if the client device rejects the steering attempt, the steering controller can continue attempting to steer to an additional candidate BSS until the client device accepts the steering, expiration of a steering timer occurs, and/or no additional candidate BSSs remain. The steering controller can steer the target client device to a candidate BSS, for example, via IEEE (Institute of Electrical and Electronics Engineers) 802.11v BSS transition management soft-steering mechanism.

An aspect of the present disclosure provides an access point device for steering a target client device from a current BSS to a candidate BSS. The access point device comprises a memory storing one or more computer-readable instructions and a processor. The processor is configured to execute the one or more computer-readable instructions to determine a link quality issue associated with the target client device based on a comparison of one or more target link quality parameters to a first link quality threshold, wherein the first link quality threshold is indicative of a target network performance associated with the target client device, determine that one or more non-associated client (NAC) link quality parameters are not available for one or more network devices, select a candidate BSS of the one or more network devices for which the one or more NAC link quality parameters are not available, and steer the target client device to the candidate BSS, wherein the steering comprises sending a steering query to the target client device to steer to the target client device to the candidate BSS, wherein the steering query indicates the candidate BSS and receiving a response from the target client device indicative of the steering to the candidate BSS.

In an aspect of the present disclosure, the processor is further configured to execute the one or more computer-readable instructions to In an aspect of the present disclosure, request the one or more NAC link quality parameters for one or more candidate BSSs of the one or more NAC network devices, compare the one or more NAC link quality parameters to a second link quality threshold, wherein the second link quality threshold is indicative of a NAC network performance associated with the one or more NAC network devices, and wherein selecting the candidate BSS is based on the comparison of the one or more NAC link quality parameters to a second link quality threshold.

In an aspect of the present disclosure, the selecting the candidate BSS is based on one or more steering conditions.

In an aspect of the present disclosure, the processor is further configured to execute the one or more computer-readable instructions to select another candidate BSS based on the response from the target client device, wherein the response indicates that the target client device did not steer to the candidate BSS, send another steering query to the target client device to steer the target client device to the another candidate BSS, wherein the steering query indicates the another candidate BSS, and receive another response from the target client device indicative of the steering to the another candidate BSS, wherein the another response indicates that the target client device accepted steering to the another candidate BSS.

In an aspect of the present disclosure, the candidate BSS is associated with a first band and the another candidate BSS is associated with a second band, wherein the first band and the second band are different.

In an aspect of the present disclosure, the processor is further configured to execute the one or more computer-readable instructions to determine that steering is enabled for the target client device based on a steering setting.

In an aspect of the present disclosure, the one or more NAC link quality parameters comprise at least one of a received signal strength indicator, and a reference signal received power.

An aspect of the present disclosure provides a method for steering a target client device from a current BSS to a candidate BSS. The method comprises determining a link quality issue associated with the target client device based on a comparison of one or more target link quality parameters to a first link quality threshold, wherein the first link quality threshold is indicative of a target network performance associated with the target client device, determining that one or more non-associated client (NAC) link quality parameters are not available for one or more network devices, and steering the target client device to the candidate BSS, wherein the steering comprises sending a steering query to the target client device to steer to the target client device to the candidate BSS, wherein the steering query indicates the candidate BSS and receiving a response from the target client device indicative of the steering to the candidate BSS.

In an aspect of the present disclosure, the method further comprises requesting the one or more NAC link quality parameters for one or more candidate BSSs of the one or more NAC network devices, comparing the one or more NAC link quality parameters to a second link quality threshold, wherein the second link quality threshold is indicative of a NAC network performance associated with the one or more NAC network devices, and wherein selecting the candidate BSS is based on the comparison of the one or more NAC link quality parameters to a second link quality threshold.

In an aspect of the present disclosure, the method is such that the selecting the candidate BSS is based on one or more steering conditions.

In an aspect of the present disclosure, the method further comprises selecting another candidate BSS based on the response from the target client device, wherein the response indicates that the target client device did not steer to the candidate BSS, sending another steering query to the target client device to steer the target client device to the another candidate BSS, wherein the steering query indicates the another candidate BSS, and receiving another response from the target client device indicative of the steering to the another candidate BSS, wherein the another response indicates that the target client device accepted steering to the another candidate BSS.

In an aspect of the present disclosure, the method is such that the candidate BSS is associated with a first band and the another candidate BSS is associated with a second band, wherein the first band and the second band are different.

In an aspect of the present disclosure, the method further comprises determining that steering is enabled for the target client device based on a steering setting.

In an aspect of the present disclosure, the method is such that the one or more NAC link quality parameters comprise at least one of a received signal strength indicator, and a reference signal received power.

An aspect of the present disclosure provides a non-transitory computer-readable medium of an access point device storing one or more instructions for steering a target client device from a current BSS to a candidate BSS within a network environment. The one or more instructions when executed by a processor of the access point device, cause the access point device to perform one or more operations including any one or more of the steps of the methods described above

### BRIEF DESCRIPTION OF DRAWINGS

In the drawings, like reference numbers generally indicate identical, functionally similar, and/or structurally similar elements.

FIG. 1 is a schematic diagram of a steering system of a network environment, according to one or more aspects of the present disclosure;

FIG. 2 is a more detailed block diagram illustrating various components of a network environment of FIG. 1, according to one or more aspects of the present disclosure;

FIG. 3 is a diagram illustrating steering of a client device to mitigate having a stranded client device within the mesh network, according to one or more aspects of the present disclosure;

FIG. 4 is a diagram illustrating steering various client devices within a mesh network to mitigate stranding of a client device, according to one or more aspects of the present disclosure;

FIG. 5 is a flowchart illustrating a method for steering a client device in a network environment to mitigating stranding of a client device, according to one or more aspects of the present disclosure; and

FIG. 6 is a flow chart illustrating a method for mitigating stranding of a client device by steering the client device, according to one or more aspects of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples and not for the purpose of limiting the present disclosure as defined by the appended claims and their equivalents. The words and phrases used in the following description and claims are merely used to enable a clear and consistent understanding of the present disclosure. In addition, descriptions of well-known structures, functions, and configurations may be omitted for clarity and conciseness. Those of ordinary skill in the art will recognize that various changes and modifications of the examples described herein can be made without departing from the spirit and scope of the present disclosure.

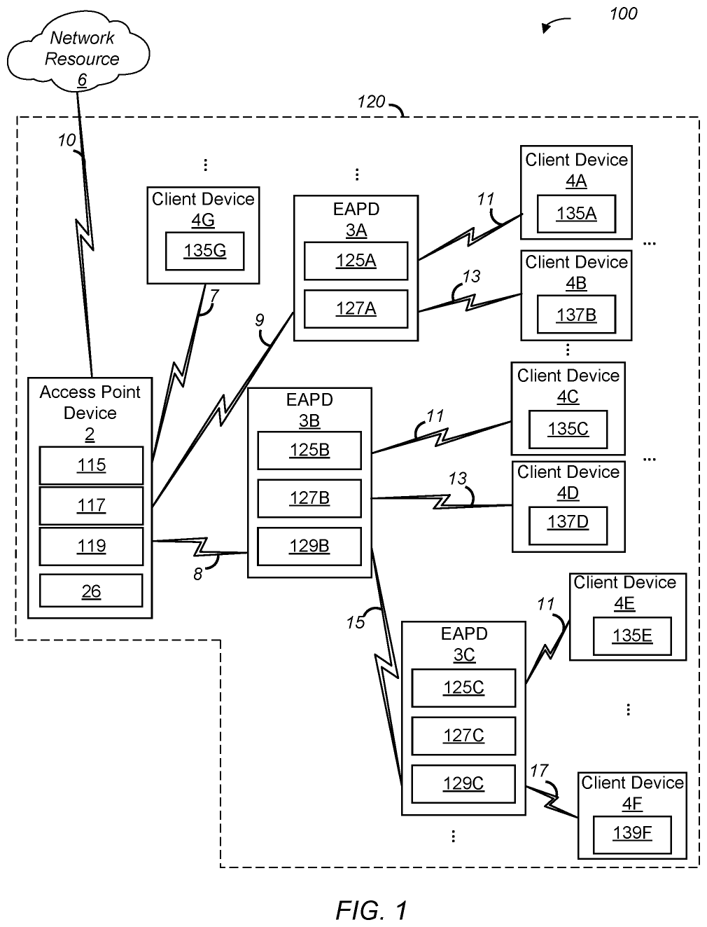

FIG. 1 is a schematic diagram of a steering system 100 of a network environment 120, according to one or more aspects of the present disclosure. The network environment 120 can comprise a mesh network that utilizes a Wi-Fi network to interconnect one or more network devices or electronic apparatuses.

It should be appreciated that various example embodiments of inventive concepts disclosed herein are not limited to specific numbers or combinations of network devices, and there may be one or multiple of some of the aforementioned network devices in the system, which may itself consist of multiple communication networks and various known or future developed wireless connectivity technologies, protocols, devices, and the like.

As shown in FIG. 1, the steering system 100 includes one or more network devices, such as an access point device (APD) 2 connected to a network resource 6, for example, an Internet Service Provider, the Internet, a repository, a web page, a server, a network service, any other network resource, or any combination thereof, one or more wireless devices (for example, one or more extender access point devices (EAPD) 3 and/or one or more client devices 4) that may be connected in one or more wireless networks (for example, a private network, a guest network, an iControl, a backhaul network, or an Internet of things (IoT) network), any other network devices, or any combination thereof. One or more network devices could be located in more than one network. For example, the wireless extender access point devices 3 could be located both in a private network for providing content and information to a client device 4 and also included in a backhaul network or an iControl network.

The access point device 2 can be, for example, a hardware electronic device that may be a combination modem and network gateway device that combines the functions of a modem, an access point (AP), a gateway, a residential gateway (RG), a broadband access gateway, a home network gateway, a router, a home router, an extender access point device 3, any other network devices that comprises a steering controller 26 (including, but not limited to, a home network controller (HNC)), or any combination thereof. It is also contemplated by the present disclosure that the access point device 2 can include the function of, but is not limited to, an Internet Protocol/Quadrature Amplitude Modulator (IP/QAM) set-top box (STB) or smart media device (SMD) that is capable of decoding audio/video content, and playing over-the-top (OTT) or multiple system operator (MSO) provided content. The steering controller 26 can provide an improved network by steering a client device 4 for which NAC link quality parameters are not available (a stranded client device) to a different BSS so as to obtain improved network performance, such as higher throughput, lower latency, etc. according to one or more aspects of the present disclosure.

The access point device 2 can include one or more wireless interfaces, including but not limited to, one or more radios such as a 2.4 GHz radio 115, a 5 GHz radio 117, and a 6 GHz radio 119. While FIG. 1 illustrates radios 115, 117, and 119, the present disclosure contemplates any number of radios at any given frequency, such as a 60 GHz radio.

The connections 7, 8 and 9 between the access point device 2 and the one or more extender access point devices 3 and/or one or more client devices 4 are implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the citizen broadband radio services (CBRS) band, 2.4 GHz bands, 5 GHz bands, 6 GHz bands, 60 GHz bands, any other bands, or any combination thereof. In one or more embodiments, any of connections 7, 8 and 9 can be a wired connection.

The connections 8 and 9 between the access point device 2 and one or more extender access point devices 3 can be implemented using any radio of the access point device 2 and any radio of the extender access point device 3. For example, the access point device 2 can utilize a radio 117 to establish a connection 9 to a radio 127A of extender access point device 3A and a radio 119 to establish a connection 8 to a radio 129B of extender access point device 3B.

The connections 7, 8, 9, and 10 between the access point device 2, the network resource 6, the one or more extender access point devices 3, and the one or more client devices 4 can be implemented using a wireless connection in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. Additionally, any one or more connections can be implemented using a wireless connection that operates in accordance with, but is not limited to, RF4CE protocol, ZigBee protocol, Z-Wave protocol, or IEEE 802.15.4 protocol. It is also contemplated by the present disclosure that any one or more connections can include connections to a media over coax (MoCA) network.

The steering system 100 can include one or more extender access point devices 3, for example, extender access point devices 3A, 3B, and 3C. An extender access point device 3 can comprise one or more radios, for example, a 2.4 GHz radio 125 (such as radios 125A, 125B and 125C of extender access point devices 3A, 3B and 3C), a 5 GHz radio 127 (such as radios 127A, 127B, and 127C of extender access point devices 3A, 3B and 3C, respectively), a 6 GHz radio 129 (such as radios 129B and 129C of extender access point devices 3B and 3C, respectively), any other radio, or any combination thereof. The one or more extender access point devices can be, for example, hardware electronic devices such as access points used to extend the wireless network by receiving the signals transmitted by the access point device 2 and rebroadcasting the signals to, for example, one or more client devices 4, which may be out of range of the access point device 2. The one or more extender access point devices 3 can also receive signals from the one or more client devices 4 and rebroadcast the signals to the access point device 2 and/or other client devices 4.

The connections 11, 13 and 15 between respective extender access point devices 3 and one or more client devices 4 is implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of these connections can also be a wired Ethernet connection.

The connection 8 between respective extender access point devices 3 can be implemented using the 6 GHz radio 129 of a wireless extenders 3, for example. The connection 8 enables the wireless extenders 3 to establish a dedicated 6 GHz wireless backhaul (6 GHz BH) according to example embodiments of the present disclosure. For example, a radio 129B of an extender access point device 3B and radio 119 of access point device 2 can be utilized to establish a wireless BH. However, the connection 8 could also be implemented using respective wired interfaces (such as Ethernet, cable, fiber optic, or the like) in some alternative example embodiments.

The steering system 100 can include one or more client devices 4, for example, client devices 4A, 4B, 4C, 4D, 4E, 4F, and 4G. A client device 4 can include a radio such as a 2.4 GHz radio 135 (such as radios 135A, 135C, 135E, and 135G of client devices 4A, 4E and 4G, respectively), a 5 GHz radio 137 (such as radios 137B and 137D of client devices 4B and 4D, respectively), a 6 GHz 139 (such as radio 139F of client device 4F), any other radio, or any combination thereof. The client devices 4 can be, for example, hand-held computing devices, personal computers, electronic tablets, smart phones, smart speakers, Internet-of-Things (IoT) devices, iControl devices, portable music players with smart capabilities capable of connecting to the Internet, cellular networks, and interconnecting with other devices via Wi-Fi and Bluetooth, or other wireless hand-held consumer electronic devices capable of executing and displaying content received through the access point device 2. Additionally, the client devices 4 can be a television (TV), an IP/QAM set-top box (STB) or a streaming media decoder (SMD) that is capable of decoding audio/video content, and playing over OTT or MSO provided content received through the access point device 2.

The connection 7 between the access point device 2 and the client device 4 can be implemented through a wireless connection that operates in accordance with, but is not limited to, any IEEE 802.11 protocols. Additionally, the connection 7 between the gateway device 2 and the client device 4 can also be implemented through a WAN, a LAN, a VPN, MANs, PANs, WLANs, SANs, a DOCSIS network, a fiber optics network (e.g., FTTH, FTTX, or HFC), a PSDN, a global Telex network, or a 2G, 3G, 4G, 5G, etc. network, for example. The connection 7 can also be implemented using a wireless connection in accordance with Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. One or more of the connections 10 can also be a wired Ethernet connection.

The connection 7 between the client device 4G and the access point device 2 can be implemented using the 2.4 GHz radio 135G of the client device 4G and the 2.4 GHz radio 115 of the access point device 2, for example. The connection 7 enables the access point device 2 and the client device 4 to establish a 2.4 GHz wireless fronthaul (6 GHz FH) according to example embodiments of the present disclosure. However, the connection 7 could also be implemented using respective wired interfaces (such as Ethernet, cable, fiber optic, or the like) in some alternative example embodiments.

The connections 11, 13, 15, and 17 between one or more extender access point devices 3 and one or more other extender access point devices 3 or one or more client devices 4 is implemented through a wireless connection that operates in accordance with any IEEE 802.11 Wi-Fi protocols, Bluetooth protocols, Bluetooth Low Energy (BLE), or other short range protocols that operate in accordance with a wireless technology standard for exchanging data over short distances using any licensed or unlicensed band such as the CBRS band, 2.4 GHz bands, 5 GHz bands, 6 GHz bands, or 60 GHz bands. Additionally, any of these connection can be implemented using a wireless connection that operates in accordance with, but is not limited to, RF4CE protocol, ZigBee protocol, Z-Wave protocol, or IEEE 802.15.4 protocol. Also, one or more of the connections 11, 13, 15, and 17 can be a wired Ethernet connection.

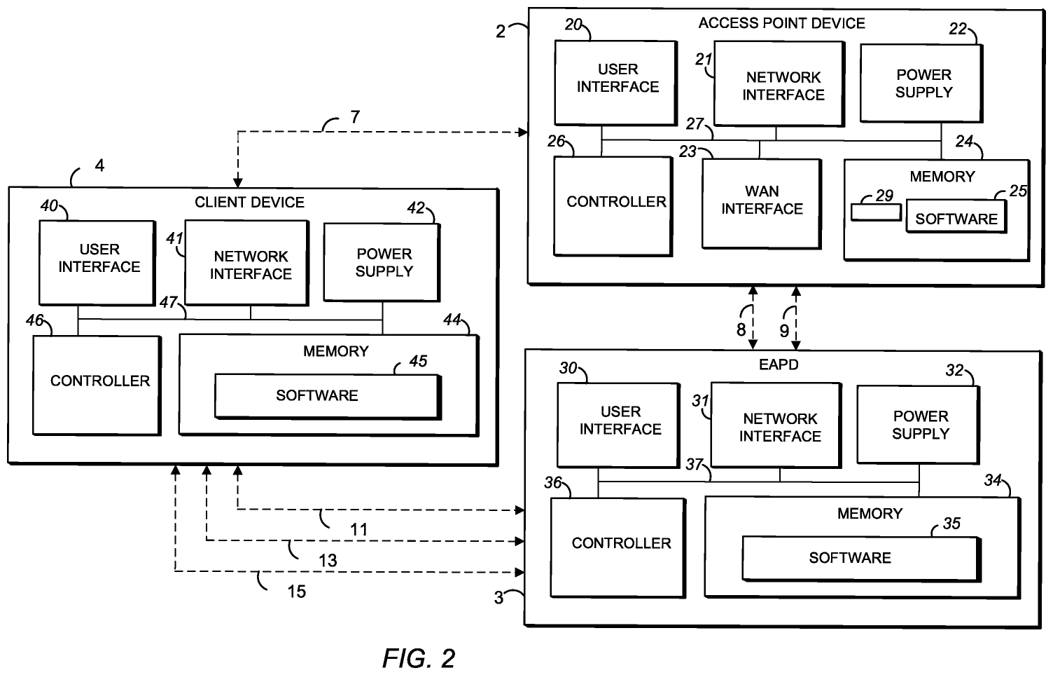

A more detailed description of the exemplary internal components of the gateway device 2, the wireless extenders 3, and the client devices 4 shown in FIG. 1 will be provided in the discussion of FIG. 2. However, in general, it is contemplated by the present disclosure that the access point device 2, the extender access point device 3, and the client devices 4 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium (e.g., a non-transitory computer-readable medium).

Further, any, all, or some of the computing components in the access point device 2, the extender access point devices 3, and the client devices 4, may be adapted to execute any operating system, including Linux, UNIX, Windows, MacOS, DOS, and ChromOS as well as virtual machines adapted to virtualize execution of a particular operating system, including customized and proprietary operating systems. The access point device 2, the extender access point devices 3, and the client devices 4 are further equipped with components to facilitate communication with other computing devices over the one or more network connections to local and wide area networks, wireless and wired networks, public and private networks, and any other communication network enabling communication in the system.

FIG. 2 is a more detailed block diagram illustrating various components of a network environment, according to one or more aspects of the present disclosure.

Although FIG. 2 only shows one extender access point device 3 and one client device 4, the extender access point device 3 and the client device 4 shown in the figure are meant to be representative of the other extender access point device 3 and client devices 4 shown in FIG. 1. Similarly, the connections 8, 9, 10, and 11 between the gateway device 2, the wireless extender 3, and the client device 4 shown in FIG. 2 are meant to be exemplary connections and are not meant to indicate all possible connections between the gateway devices 2, extender access point devices 3, and client devices 4. Additionally, it is contemplated by the present disclosure that the number of access point devices 2, extender access point devices 3, and client devices 4 is not limited to the number of access point devices 2, extender access point devices 3, and client devices 4 shown in FIGS. 1 and 2.

Now referring to FIG. 2 (for example, from left to right), the client device 4 can be, for example, a computer, a portable device, an electronic tablet, an e-reader, a PDA, a smart phone, a smart speaker, an IoT device, an iControl device, portable music player with smart capabilities capable of connecting to the Internet, cellular networks, and interconnecting with other devices via Wi-Fi and Bluetooth, or other wireless hand-held consumer electronic device capable of executing and displaying the content received through the access point device 2. Additionally, the client device 4 can be a TV, an IP/QAM STB, or an SMD that is capable of decoding audio/video content, and playing over OTT or MSO provided content received through the access point device 2.

As shown in FIG. 2, the client device 4 includes a user interface 40, a network interface 41, a power supply 42, a memory 44, and a local controller 46. The user interface 40 includes, but is not limited to, push buttons, a keyboard, a keypad, a liquid crystal display (LCD), a thin film transistor (TFT), a light-emitting diode (LED), a high definition (HD) or other similar display device including a display device having touch screen capabilities to allow interaction between a user and the client device 4. The network interface 41 can include, but is not limited to, various network cards, interfaces, and circuitry implemented in software and/or hardware to enable communications with the access point device 2 and the extender access point device 3 using the communication protocols in accordance with connections 7, 11, 13, and 15 (for example, as described with reference to FIG. 1). The network interface 41 can include multiple radios (for example, a 2.4 GHz radio, a 5 GHz radio, a 6 GHz radio, a 60 GHz radio, any other radio, or any combination thereof), which may also be referred to as wireless local area network (WLAN) interfaces. Any one or more of the radios can provide a fronthaul (FH) connection between the client device(s) 4 and the access point device 2 and/or the extender access point device 3.

The power supply 42 supplies power to the internal components of the client device 4 through the internal bus 47. The power supply 42 can be a self-contained power source such as a battery pack with an interface to be powered through an electrical charger connected to an outlet (for example, either directly or by way of another device). The power supply 42 can also include a rechargeable battery that can be detached allowing for replacement such as a nickel-cadmium (NiCd), nickel metal hydride (NiMH), a lithium-ion (Li-ion), or a lithium Polymer (Li-pol) battery.

The memory 44 includes a single memory or one or more memories or memory locations that include, but are not limited to, a random access memory (RAM), a dynamic random access memory (DRAM) a memory buffer, a hard drive, a database, an erasable programmable read only memory (EPROM), an electrically erasable programmable read only memory (EEPROM), a read only memory (ROM), a flash memory, logic blocks of a field programmable gate array (FPGA), a hard disk or any other various layers of memory hierarchy. The memory 44 can be used to store any type of instructions, software, or algorithms including software 45 for controlling the general function and operations of the client device 4 in accordance with the embodiments described in the present disclosure.

The local controller 46 controls the general operations of the client device 4 and includes, but is not limited to, a central processing unit (CPU), a hardware microprocessor, a hardware processor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software including the software 45 for controlling the operation and functions of the client device 4 in accordance with the embodiments described in the present disclosure. Communication between the components (for example, 40, 41, 42, 44, 46) of the client device 4 may be established using an internal bus 47.

The extender access point device 3 can be, for example, a hardware electronic device such as an access point used to extend a wireless network by receiving the signals transmitted by the access point device 2 and rebroadcasting the signals to client devices 4, which may be out of range of the access point device 2. The extender access point device 3 can also receive signals from the client devices 4 and rebroadcast the signals to the gateway device 2, mobile device 5, or other client devices 4.

As shown in FIG. 2, the extender access point device 3 includes a user interface 30, a network interface 31, a power supply 32, a memory 34, and a local controller 36. The user interface 30 can include, but is not limited to, push buttons, a keyboard, a keypad, an LCD, a TFT, an LED, an HD or other similar display device including a display device having touch screen capabilities so as to allow interaction between a user and the wireless extender 3. The network interface 31 can include various network cards, interfaces, and circuitry implemented in software and/or hardware to enable communications with the client device 4 and the access point device 2 using the communication protocols in accordance with connections 8, 9, 11, 12 and/or 13 (for example, as described with reference to FIG. 1). For example, the network interface 31 can include multiple radios or sets of radios (for example, a 2.4 GHz radio, a 5 GHz radio, a 6 GHz radio, a 60 GHz radio, any other radio, or any combination thereof), which may also be referred to as wireless local area network (WLAN) interfaces. One radio or set of radios provides a backhaul (BH) connection between the extender access point device 3 and the access point device 2, and optionally other extender access point device(s) 3. Another radio or set of radios provides a fronthaul (FH) connection between the extender access point device 3 and one or more client device(s) 4.

The power supply 32 supplies power to the internal components of the wireless extender 3 through the internal bus 37. The power supply 32 can be connected to an electrical outlet (for example, either directly or by way of another device) via a cable or wire. The memory 34 can include a single memory or one or more memories or memory locations that include, but are not limited to, a RAM, a DRAM, a memory buffer, a hard drive, a database, an EPROM, an EEPROM, a ROM, a flash memory, logic blocks of an FPGA, hard disk or any other various layers of memory hierarchy. The memory 34 can be used to store any type of instructions, software, or algorithm including software 35 associated with controlling the general functions and operations of the extender access point device 3 in accordance with the embodiments described in the present disclosure.

The local controller 36 controls the general operations of the extender access point device 3 and can include, but is not limited to, a CPU, a hardware microprocessor, a hardware processor, a multi-core processor, a single core processor, an FPGA, a microcontroller, an ASIC, a DSP, or other similar processing device capable of executing any type of instructions, algorithms, or software including the software 35 for controlling the operation and functions of the extender access point device 3 in accordance with the embodiments described in the present disclosure. General communication between the components (for example, 30, 31, 32, 34, 36) of the extender access point device 3 may be established using the internal bus 37.

The access point device 2 can be, for example, a hardware electronic device that can combine the functions of a modem, an access point (AP), and/or a router for providing content received from the content provider (ISP) 1 to network devices (for example, extender access point device 3, client devices 4) in the system. It is also contemplated by the present disclosure that the access point device 2 can include the function of, but is not limited to, an IP/QAM STB or SMD that is capable of decoding audio/video content, and playing OTT or MSO provided content.

As shown in FIG. 2, the access point device 2 includes a user interface 20, a network interface 21, a power supply 22, a wide area network (WAN) interface 23, a memory 24, and a steering controller 26. The user interface 20 can include, but is not limited to, push buttons, a keyboard, a keypad, an LCD, a TFT, an LED, an HD or other similar display device including a display device having touch screen capabilities so as to allow interaction between a user and the gateway device 2. The network interface 21 may include various network cards, and circuitry implemented in software and/or hardware to enable communications with the extender access point device 3 and the client device 4 using the communication protocols in accordance with connections 7, 8, 9, 11, 13, and/or 15 (for example, as described with reference to FIG. 1). For example, the network interface 21 can include an Ethernet port (also referred to as a LAN interface) and multiple radios or sets of radios (for example, a 2.4 GHz radio, a 5 GHz radio, a 6 GHz radio, a 60 GHz radio, any other radio or any combination thereof also referred to as WLAN interfaces). One radio or set of radios can provide a wireless backhaul (BH) connection between the access point device 2 and the extender access point device(s) 3. Another radio or set of radios can provide a fronthaul (FH) connection between the access point device 2 and one or more client device(s) 4.

The power supply 22 supplies power to the internal components of the access point device 2 through the internal bus 27. The power supply 22 can be connected to an electrical outlet (for example, either directly or by way of another device) via a cable or wire. The WAN interface 23 may include various network cards, and circuitry implemented in software and/or hardware to enable communications between the access point device 2 and the network resource 6 using the wired and/or wireless protocols in accordance with connection 10 (for example, as described with reference to FIG. 1). For example, the WAN interface 23 can include an Ethernet port and one or more radios (for example, a 6 GHz radio). The WAN interface 23 (for example, a 6 GHz radio) may be used to provide a wireless backhaul (BH) connection between the access point device 2 and any one or more other elements, according to example embodiments of the present disclosure. However, the WAN interface 23 could provide a wired Ethernet connection (for example, a BH connection) between the access point device 2 and any other element according to some alternative example embodiments.

The memory 24 includes a single memory or one or more memories or memory locations that include, but are not limited to, a RAM, a DRAM, a memory buffer, a hard drive, a database, an EPROM, an EEPROM, a ROM, a flash memory, logic blocks of a FPGA, hard disk or any other various layers of memory hierarchy. The memory 24 can be used to store any type of instructions, software, or algorithm including software 25 for controlling the general functions and operations of the access point device 2 and performing management functions related to the other devices (for example, extender access point devices 3 and client devices 4) in the network in accordance with the embodiments described in the present disclosure. The memory 24 can store one or more link quality thresholds (such as a first link quality threshold and/or a second link quality threshold) associated with one or more link quality parameters (for example, a first link quality RSSI threshold and/or a second link quality RSSI threshold, a first link quality RCPI threshold and/or a second link quality RCPI threshold, a first link quality PHY rate threshold and/or a second link quality PHY rate threshold, any other link quality threshold, or any combination thereof. The one or more link quality thresholds can be indicative of a target network performance. For example, a first link quality threshold can correspond to a lower link quality threshold or a poor link quality threshold and the second link quality threshold can correspond to an upper link quality threshold, or a good link quality threshold, or any other designated range. A first or poor link quality threshold can identify a boundary or value indicative of a poor quality or unacceptable network performance or network environment while an upper or good link quality threshold can identify a boundary or value indicative of an acceptable network performance.

The one or more link quality parameters can correspond to a target client device 4 (one or more target link quality parameters) and/or one or more NAC BSSs on one or more network devices (one or more NAC link quality parameters). The one or more target link quality parameters can comprise any of a power data (such as link quality RSSI data, link quality RCPI data, etc.), a PHY rate data, any other link quality data, or any combination thereof that are received from the client device 4 for the currently associated BSS on the current network device. The one or more NAC link quality parameters can comprise any of NAC data such as any of power NAC data (such as a link quality RSSI NAC data, a link quality RCPI NAC data, etc.), any other link quality NAC data, or any combination thereof. The steering controller 26 can use the link quality threshold for comparison with a received or measured link quality parameter to determine whether to attempt to steer a target client device to a candidate BSS.

The steering controller 26 controls the general operations of the access point device 2 as well as performs management functions related to the other devices (for example, extender access point device 3 and client device 4) in the network. The steering controller 26 may also be referred to as a HNC. The steering controller 26 can include, but is not limited to, a central processing unit (CPU), a hardware microprocessor, a hardware processor, a multi-core processor, a single core processor, a FPGA, a microcontroller, an ASIC, a DSP, or other similar processing device capable of executing any type of instructions, algorithms, or software including the software 25 for controlling the operation and functions of the access point device 2 in accordance with the embodiments described in the present disclosure. Communication between the components (for example, 20, 21, 22, 23, 24, 26) of the access point device 2 may be established using the internal bus 27. The steering controller 26 may also be referred to as a processor, generally.

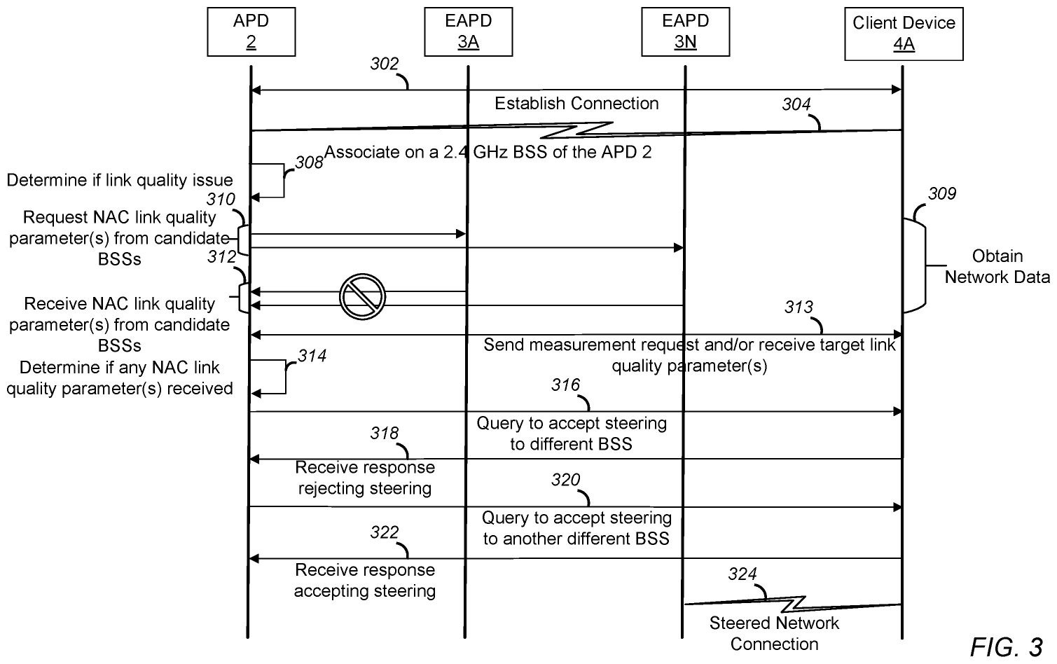

FIG. 3 is a diagram illustrating steering of a client device 4A to improve network performance within the mesh network 120, according to one or more aspects of the present disclosure. As an example, when a client device 4A comes within proximity of a network, for example, a mesh network 120, the client device 4A at 302 establishes a connection with an access point device 2. In this example, a steering controller 26 of access point device 2 originally associates the client device 4A at 304 with a 2.4 GHz BSS of the access point device 2 (the original or current BSS) instead of another BSS on the access point device 2 (for example, a 5 GHz BSS on the access point device 2) or on other network devices within the mesh network 120, for example, extender access point devices 3A and 3N (where N represents any number of extender access point devices 3), any other network devices, or any combination thereof. The client device 4A can then be transitioned to one or more other locations within the mesh network 120 such that the original BSS may not provide an acceptable or good network performance. As an example, this original BSS associated with the network connection between the client device 4A (also referred to as the target client device) and the access point device 2 can have a target link quality RSSI of −82 dBm (the client device 4A stays associated on a 2.4 GHz BSS on the access point device 2), which for purposes of this example is considered to be a poor network performance. The first link quality RSSI threshold can be set for the mesh network 120 at −75 dBm, the NAC link quality RSSI associated with the 5 GHz BSS on the access point device 2 can be estimated to be less than −82 dBm and one or more NAC link quality parameters (such as NAC link quality parameters associated with extender access point devices 3A and/or 3N) are not obtainable, are inaccessible, and/or are missing for extender devices 3A and 3N, for example, because client device 4A is associated with a different channel or band than the extender access point devices 3A and/or 3N. For example, extender access point device 3A could have a 5 GHz BSS with an associated link quality RSSI of −69 dBm for client device 4A and extender access point device 3N could have a 5 GHz BSS associated with a link quality of −58 dBm for client device 4A (where connection to either would result in an improved network performance experienced by client device 4A) but the NAC link quality parameter(s) associated with these extender access point devices 3A and 3N are not available or accessible for client device 4A due to client device 4A being associated with a 2.4 GHz BSS. Typically, no steering attempt will be made by the access point device 2 for the client device 4A given these conditions and the client device 4A will remain stranded on the 2.4 GHz BSS of the access point device 2 even though another BSS may provide an improved network performance or a network environment.

At 308, the steering controller 26 determines if there is a link quality issue associated with the current or original BSS of the client device 4A based on the one or more received target link quality parameters, for example, RSSI, RCPI, PHY rate, etc., measured for the client device 4A that is associated with the original BSS on the access point device 2. For example, the steering controller 26 can compare a target link quality parameter associated with the client device 4A to a first (or a poor) link quality threshold, such as to determine if the target link quality parameter is at, below or exceeds the first link quality threshold. In this example, the target link quality RSSI (−82 dBm) is less than the first link quality threshold of −75 dBm. The first link quality threshold can be stored in a memory 24 of the access point device 2 or retrieved from a network resource 6.

Based on the comparison at 308 indicating a poor network performance and/or network environment, the steering controller 26 attempts to obtain network data, for example, one or more NAC link quality parameters from one or more network devices associated with the mesh network 120, such as extender access point devices 3A and 3N. For example, at 310, the steering controller 26 can periodically request, query, or otherwise poll one or more network devices on a different or candidate BSS than the original BSS for one or more link quality parameters (one or more NAC link quality parameters). The steering controller 26 requests one or more NAC link quality parameters associated with a different or candidate BSS on extender access point devices 3A and 3N.

At 312, the steering controller 26 could receive the requested one or more NAC link quality parameters from the extender access point devices 3A and 3N. However, under certain circumstances, the one or more NAC link quality parameters from one or more other network devices, such as extender access point devices 3A and 3N are not available or accessible and thus client device 4A can become stranded (for example, the one or more NAC link quality parameters are not received at 312). To avoid stranding client device 4A, at 314 the steering processor 26 can determine if any NAC link quality parameters associated with a BSS on another network device have been received. If no NAC link quality parameters associated with a BSS on another network device have been received then at 313 the steering processor 26 can also send an IEEE 802.11k beacon request to client device 4A for client device 4A to send one or more NAC link quality parameters for a BSS on extender access point devices 3A and/or 3N. If client device 4A does not support either IEEE 802.11k beacon reporting or providing an accurate beacon report following the IEEE 802.11k beacon request (which are not common scenarios), then the steering controller 26 determines at 314 that the client device 4A is stranded and can proceed with an alternative steering.

The steering controller 26 can determine, identify or otherwise select a candidate BSS of a network device (for example, extender access point devices 3A and 3N) for steering of the client device 4A based on one or more steering conditions. For example, the steering controller 26 can select a first candidate BSS on a first network device, such as extender access point device 3A, where the one or more steering conditions indicate that extender access point device 3A is associated with a 5 GHz BSS for a NAC network device. At 316, the steering controller can send a first steering query, such as a first steering request and/or one or more first steering instructions, to the client device 4A to accept steering to the extender access point device 3A. The steering controller 26 can utilize 802.11v BSS transition management when attempting to steer the client device 4A to the selected or identified network device so as to allow the client device 4A to decide if the client device 4A approves the move given the lack of one or more NAC link quality parameters received. At 318, the steering controller 26 can receive a first steering response to the first steering query from the client device 4A. The first steering response can indicate that steering to the first candidate BSS indicated in the first steering query was accepted or denied.

If at 318 the first steering response indicates that steering to the first candidate BSS was not accepted, then at 320, the steering controller 26 can select a second candidate BSS on a second network device, such as extender access point device 3N and send a second steering query to the client device 4A to request that the client device 4A steer to the second candidate BSS similar to or the same as at 316. At 322, the steering controller 26 can receive a second steering response from the client device 4A that indicates that the second steering query was accepted and as such at 324 the client device 4A steers to the second candidate BSS or establishes a network connection to the second candidate BSS of the extender access point device 3N.

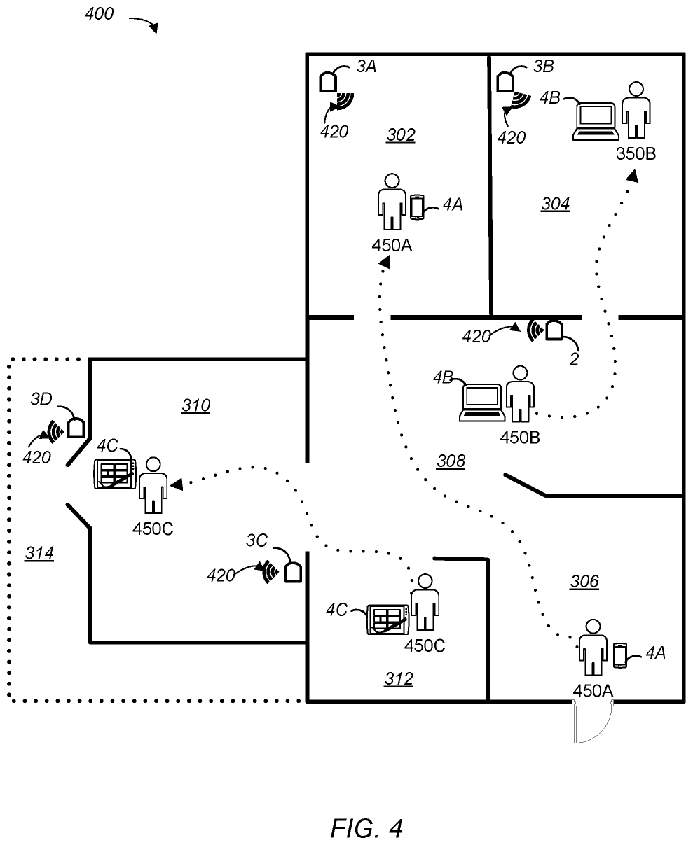

FIG. 4 is a diagram illustrating a network environment 400 for steering various target client devices 4 within a mesh network 420 to improve network performance, according to one or more aspects of the present disclosure. Mesh network 420 can be similar to or the same as mesh network 120 discussed with reference to FIG. 1. The mesh network 400 can comprise one or more users 450, such as users 450A, 450B and 450C and one or more network devices, such as target client devices 4A, 4B, and 4C associated with users 450A, 450B, and 450C, respectively, extender access point devices 3A, 3B, 3C and 3D disposed or positioned at locations 302, 304, 310 and 314, and access point device 2 disposed or positioned at location 308. The access point device 2 can comprise a steering controller 26 that can attempt to steer any one or more target client devices 4 to another BSS based on a determination of a link quality issue associated with the target client device 4, for example, based on a determination that a target link quality parameter is at, below or exceeds a first or a poor link quality threshold (such as a first link quality RSSI threshold).

A user 450A can enter a network environment 400 at a location 306, for example, a foyer or entrance, with a target client device 4A, for example, a cellular telephone with Wi-Fi functionality. The target client device 4A is within proximity of the access point device 2 and establishes a network connection to the mesh network 420 via the access point device 2. The target client device 4A associates with a first BSS on the access point device 2 (for example, a 2.4 GHz BSS) with an associated first target link quality parameter link quality (for example, a link quality RSSI of −82 dBM. The user 450A transitions with the target client device 4A from the location 306 to a location 302, for example, a bedroom or business center, that comprises a second BSS on an extender access point device 3A that is different than the first BSS. The target client device 4A remains associated with the first BSS (the 2.4 GHz BSS of the access point device 2).

A user 450B can be disposed or positioned at a network environment 400 at a location 308, for example, a living room or common space, with a target client device 4B, for example, a laptop or portable computer. The target client device 4B is within proximity of the access point device 2 and establishes a network connection to the mesh network 420 via the access point device 2. The target client device 4B associates with the first BSS on the access point device 2. The user 450B transitions with the target client device 4B from the location 308 to a location 304, for example, an office, that comprises a third BSS on an extender access point device 3B that is different than the first BSS.

A user 450C can be disposed or positioned at a network environment 400 at a location 312, for example, a kitchen or breakroom, with a target client device 4C, for example, a tablet computer or other handheld computing device. The target client device 4C is within proximity of the extender access point device 3C and establishes a network connection to the mesh network 420 via the extender access point device 3C. The target client device 4C associates with a fourth BSS on the extender access point device 3C that is different than the first BSS, the second BSS and the third BSS. The user 450C transitions with the target client device 4C from the location 312 to a location 310, for example, a media room or a conference room, that comprises the extender access point device 3C and is within proximity to a location 314, for example, a patio, that comprises a fifth BSS on an extender access point device 3D that is different than the first BSS, the second BSS, the third BSS, and the fourth BSS.

The target client device 4A is identified as not satisfying the first or poor link quality threshold, for example, a comparison of the first link quality RSSI of −82 dBM to a first link quality threshold indicates a link quality issue (such as the first link quality RSSI is less than the first link quality threshold). To provide an improve network experience or network performance, the steering controller 26 can attempt to steer the target client device 4A to a different BSS, for example, to extender access point device 3A. The steering controller 26 can determine that no NAC link quality parameters are available for any network device of the network environment 400. The steering controller 26 can send a steering query or a steering request to the client device 4A for the client do steer to the second BSS of the extender access point device 3A and client device 4A can send a response that indicates that the steering to the second BSS of extender access point device 3A is accepted such that the client device 4A establishes a connection to the second BSS.

With respect to the target client device 4B, the steering controller 26 can determine that one or more target link quality parameters do not satisfy the first or the poor link quality threshold and that no NAC link quality data is available or accessible to the client device 4B. The steering controller can attempt to steer the client device 4B to a different BSS on another network device. For example, the steering controller 26 can attempt to steer the client device 4B to a third BSS of the extender access point device 3B by sending a steering query or a steering request to the client device 4A indicating for the client device 4A to steer to the third BSS of the extender access point device 3B. The client device 4B can deny the steering query or the steering request by sending a steering response to the steering controller 26. The steering controller can determine based on one or more steering association conditions that no further attempts to steer the client device 4A should be made such that client device 4B remains associated with the first BSS even though one or more BSSs would provide an improved network performance or network environment. The one or more steering association conditions can comprise any of a steering attempt limit indicative of a number steering queries or steering requests that a target client device can be sent in order to steer the target client device to a different BSS, a candidate BSS limit indicative of a number of attempts that a target client device 4 can be attempted to be steered to a particular candidate BSS, an exponential backoff timer indicative of a timeframe during which the steering controller 26 can attempt to steer the target client device 4 to a different BSS such that at an expiration of the backoff timer the steering controller 26 discontinues attempts to steer the client device 4, a change in or a delta of one or more target link quality parameters at, below or that exceeds a corresponding delta threshold such that the steering controller initiates an attempt to steer the target client device 4 based on a comparison of the change in or the delta to a corresponding delta threshold (for example, the one or more target link quality parameters can meet a link quality threshold such that steering would not be attempted but the change in or the delta can indicate that the client device 4 has been moved such that a steering should be attempted), any other condition indicative of a limit on steering, or any combination thereof.

With respect to target client device 4C, the steering controller 26 can determine that there is a link quality issue once the target client device 4C is transitioned to location 310. Even though NAC link quality data for extender access point devices 3A, 3B, and 3D is not available, the steering controller 26 can systematically attempt to steer the target client device 4C to another network device to obtain an improved network performance or network environment. For example, the steering controller 26 can send a steering query to the target client device 4C to attempt to steer the target client device 4C to the second BSS of the extender access point device 3A which is rejected by the target client device 4C, then to the third BSS of the extender access point device 3B which is rejected by the target client device 4C, and then to the fifth BSS of the extender access point device 3D which is accepted by the target client device 4C. In this way, even though NAC link quality data is not available, the steering controller 26 can attempt to steer the target client device 4C to a BSS that provides an improved network performance or network environment.

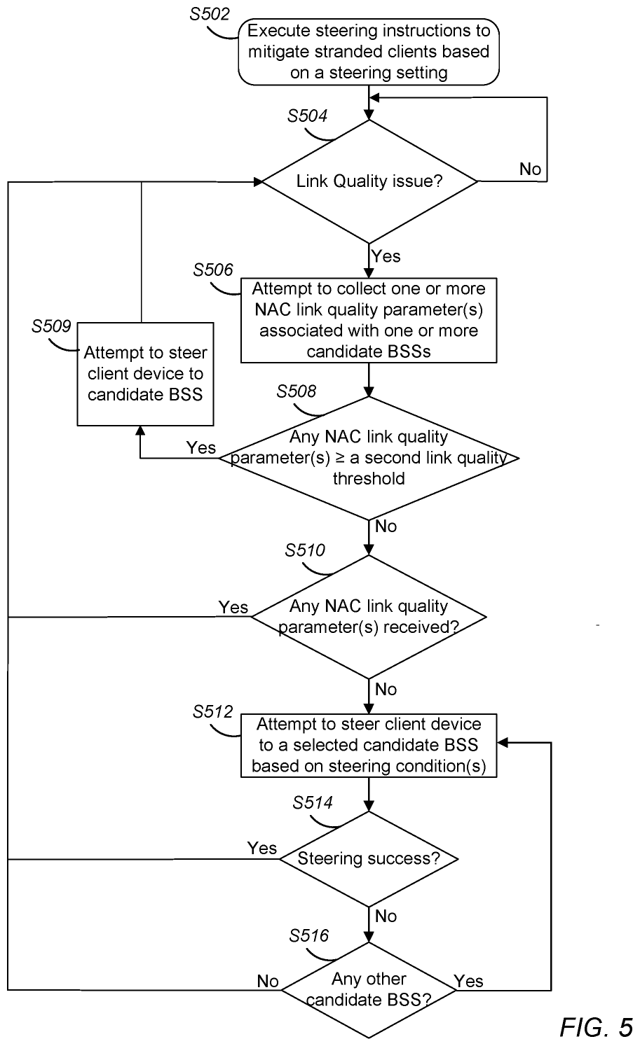

FIG. 5 is a flowchart illustrating a method for steering a target client device 4 in a network environment to improve network performance to prevent a target client device 4 from remaining stranded on a BSS that does not provide satisfactory network performance, according to one or more aspects of the present disclosure. The network environment can comprise a mesh network that includes a plurality of network devices, such as an access point 2 and one or more extender access point devices 3, a plurality of extender access point devices 3, or any combination of one or more network devices. At step S502, the steering controller 26, for example, of an access point device 2 in the network environment, executes one or more computer-readable instructions (such as one or more steering instructions) for steering one or more client devices 4 to mitigate stranded target client devices so as to improve network performance when steering functionality is enabled. For example, a memory 24 of the access point device 2 can store a steering setting 29 that indicates whether such steering is enabled for the network environment, for a particular client device 4, or both. In one or more embodiments, the access point device 2 includes a user interface that allows for the configuration of the steering setting 29, for example, by a user or an administrator.

At step S504, the steering controller 26 determines if there is a link quality issue associated with the current or original BSS on the target client device 4. The steering controller 26 can compare any one or more target client link quality parameter(s) to a first link quality threshold and based on the comparison determine that target client device 4 has a link quality issue. For example, the steering controller 26 can compare a target link quality RSSI to a first link quality RSSI threshold to determine that the target link quality RSSI is less than, equal to, or less than or equal to the first link quality RSSI threshold such that a link quality issue exists. If no link quality issue exists the steering controller 26 continues to monitor the target client device for a link quality issue.

If a link quality issue is determined, then at step S506, the steering controller 26 attempts to obtain or collect network data such as one or more NAC link quality parameters associated with one or more candidate BSSs on one or more NAC network devices within the network environment for the target client device 4. At step S508, the steering controller 26 compares the obtained or collected one or more NAC link quality parameters to a corresponding second link quality threshold. In one or more embodiments, no NAC link quality parameter is obtained or collected for any BSS and the process proceeds to step S510. In one or more embodiments, the comparison indicates, for example, that one or more NAC link quality parameters meet (for example, greater than, equal to, or greater than or equal to) a second link quality threshold and the process proceeds to step S509 where the steering controller 26 attempts to steer the target client device 4 to a candidate BSS and then continues to monitor the target client device for a link quality issue at step S504.

If the comparison at step S508 do not indicate any candidate BSS for steering of the target client device 4, at step S510, the steering controller 26 determines if any one or more NAC link quality parameters were received at step S506. If one or more NAC link quality parameters were received, the process continues at step S504. If no one or more NAC link quality parameters associated with one or more candidate BSSs on one or more NAC network devices were received, then steering controller 26 at step 512 attempts to steer the target client device 4 to a selected or identified candidate BSS of a NAC network device. The steering controller 26 can select or identify a candidate BSS based on one or more steering conditions. At step S514, the steering controller 26 can systematically or otherwise iterate through the potential candidate BSSs and determine if a selected or identified candidate BSS is accepted by the target client device 4 or the target client device 4 otherwise indicates a steering success. If the steering controller 26 receives an indication from the target client device 4 (for example, a response to a steering query), then the process continues to step S504 with the target client device 4 having been successfully steered to a different BSS. If steering was not successful at step S514, then the steering controller 26 continues to iterate through the potential candidate BSSs by continuing to step S512 until no other candidate BSS exists at which point the process continues to step S504 without the target client device 4 being steered to a different BSS.

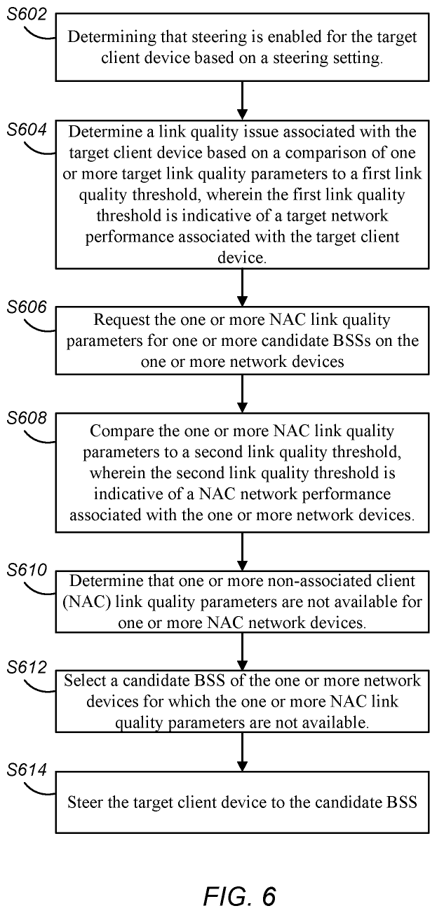

FIG. 6 is a flow chart illustrating a method for providing improved network performance by steering a stranded client device, according to one or more aspects of the present disclosure. In one or more embodiments, a network device may include a steering controller 26, such as a network device controller or HNC, that may be programmed with or to execute one or more instructions (for example, software or application 25) to perform steps for steering a target client device 4 from a current BSS to a candidate BSS, that is different than the current BSS, on a NAC network device based on a comparison to a first or poor link quality threshold. In FIG. 6, it is assumed that the network devices include their respective controllers and their respective software stored in their respective memories, as discussed above in reference to FIGS. 1-5, which when executed by their respective controllers perform the functions and operations in accordance with the example embodiments of the present disclosure (for example, including dynamic steering of client device by a steering controller 26 of an access point device).

The steering controller 26 executes one or more computer-readable instructions, stored in a memory, for example, a memory 24 of an access point device 2, that when executed perform one or more of the operations of steps S602-S614. In one or more embodiments, the one or more computer-readable instructions may be one or more software applications, for example, a software 25 of an access point device 2. While the steps S602-S614 are presented in a certain order, the present disclosure contemplates that any one or more steps can be performed simultaneously, substantially simultaneously, repeatedly, in any order or not at all (omitted).

A target client device 4 can be brought within proximity of a network environment. The target client device is associated with an original or current BSS on a network device, for example, an access point device 2 or an extender access point device 3. However, over time or as the target client device 4 is transitioned to one or more locations within the network environment, the network performance for the target client device 4 can become stranded such that the target client device remains on the current BSS even though a candidate BSS is available that can provide an improved network experience. FIG. 6 illustrates a process for mitigating the stranding of a target client device 4 by attempting to steer the target client device to a different BSS even when certain network information or data is not available. Starting at step 602, the steering controller 26 determines that steering is enabled for the target client device 4 based on a steering setting 29 stored in a memory 24 of the access point device 2. For example, the steering setting 29 can be set by a system administrator or other person or entity with a corresponding privilege. In one or more embodiments, the steering setting 29 is retrieved from a network resource 6.

At step S604, the steering controller 26 determines a link quality issue associated with the target client device 4 based on a comparison of one or more target link quality parameters to a first link quality threshold. Any one or more link quality parameters can be associated with a link quality threshold, such as the first link quality threshold. The first link quality threshold can be indicative of a target network performance associated with the target client device 4. The steering controller 26 can any of send a request to the target client device 4 for the one or more target link quality parameters and receive a response from the target client device 4 that comprises the one or more target link quality parameters, periodically receive the one or more target link quality parameters from the target client device 4, otherwise receive the one or more target link quality parameters based on any other criteria, or any combination thereof.

At step S606, the steering controller 26 can request one or more NAC link quality parameters for one or more candidate BSSs on one or more network devices. The one or more candidate BSSs are different than the current BSS. The one or more network devices can be determined or otherwise selected based on one or more steering conditions so as to minimize disruption in network performance by only requesting the one or more NAC link quality parameters for network devices that meet a steering condition.

At step S608, the steering controller 26 can compare the one or more NAC link quality parameters to a second link quality threshold. The second link quality threshold can be indicative of a NAC network performance associated with the one or more network devices. For example, the second link quality threshold can indicate a minimum network performance that is required for the BSS to be considered a candidate BSS for the steering of the client device 4.

At step S610, the steering controller 26 determines that one or more NAC link quality parameters are not available for one or more network devices. At step S612, the steering controller 26 selects a candidate BSS of the one or more network devices for which the one or more NAC link quality parameters are not available.

At step S614, the steering controller 26 steers the target client device 4 to the candidate BSS. The steering the target client device can comprise sending a steering query to the target client device 4 to steer to the target client device 4 to the candidate BSS and receiving a response from the target client device 4 indicative of the steering to the candidate BSS. The steering query can indicate the candidate BSS. If the response indicates the steering attempt was not successful (the target client device did not steer to the candidate BSS), the step S612 can be repeated such that another BSS is selected based on the response from the target client device 4. The steering controller 26 can then send another steering query to the target client device 4 to steer the target client device 4 to another candidate BSS. The steering query can indicate the another candidate BSS. In one example, the candidate BSS can be associated with a first band and the another candidate BSS is associated with a second band where the first band and the second band are different or not the same band. The steering controller 26 can receive another response from the target client device indicative of the steering to the another candidate BSS. The another response can indicate that the target client device accepted steering or steered to the another candidate BSS. The steps S612-S614 can be repeated until steering attempts to all candidate BSSs have been completed or until no further candidate BSSs are available.

In this way, the steering controller 26 mitigates the stranding of client devices and conserves network resources as only BSSs and/or network devices that meet one or more steering conditions are selected and steering is attempted based on the one or more steering conditions.

Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory, for example. The processes disclosed above constitute examples of algorithms that can be affected by software, applications (apps, or mobile apps), or computer programs. The software, applications, computer programs or algorithms can be stored on a non-transitory computer-readable medium for instructing a computer, such as a processor in an electronic apparatus, to execute the methods or algorithms described herein and shown in the drawing figures. The software and computer programs, which can also be referred to as programs, applications, components, or code, include machine instructions for a programmable processor, and can be implemented in a high-level procedural language, an object-oriented programming language, a functional programming language, a logical programming language, or an assembly language or machine language.

The term “non-transitory computer-readable medium” refers to any computer program product, apparatus or device, such as a magnetic disk, optical disk, solid-state storage device (SSD), memory, and programmable logic devices (PLDs), used to provide machine instructions or data to a programmable data processor, including a computer-readable medium that receives machine instructions as a computer-readable signal. By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, includes compact disc (CD), laser disc, optical disc, digital versatile disc (DVD), floppy disk and Blu-ray disc. Combinations of the above are also included within the scope of computer-readable media.

The word “comprise” or a derivative thereof, when used in a claim, is used in a nonexclusive sense that is not intended to exclude the presence of other elements or steps in a claimed structure or method. As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Use of the phrases “capable of,” “configured to,” or “operable to” in one or more embodiments refers to some apparatus, logic, hardware, and/or element designed in such a way to enable use thereof in a specified manner.

While the principles of the inventive concepts have been described above in connection with specific devices, apparatuses, systems, algorithms, programs and/or methods, it is to be clearly understood that this description is made only by way of example and not as limitation. The above description illustrates various example embodiments along with examples of how aspects of particular embodiments may be implemented and are presented to illustrate the flexibility and advantages of particular embodiments as defined by the following claims, and should not be deemed to be the only embodiments. One of ordinary skill in the art will appreciate that based on the above disclosure and the following claims, other arrangements, embodiments, implementations and equivalents may be employed without departing from the scope hereof as defined by the claims. It is contemplated that the implementation of the components and functions of the present disclosure can be done with any newly arising technology that may replace any of the above-implemented technologies. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What we claim is:

1. An access point device for steering a target client device from a current BSS to a candidate BSS, the access point device comprising:
a memory storing one or more computer-readable instructions; and
a processor configured to execute the one or more computer-readable instructions to:
determine a link quality issue associated with the target client device based on a comparison of one or more target link quality parameters to a first link quality threshold, wherein the first link quality threshold is indicative of a target network performance associated with the target client device;
determine that one or more non-associated client (NAC) link quality parameters are not available for one or more network devices;
select a candidate BSS of the one or more network devices for which the one or more NAC link quality parameters are not available; and
steer the target client device to the candidate BSS, wherein the steering comprises:
sending a steering query to the target client device to steer to the target client device to the candidate BSS, wherein the steering query indicates the candidate BSS; and
receiving a response from the target client device indicative of the steering to the candidate BSS.

2. The access point device of claim 1, wherein the processor is further configured to execute the one or more computer-readable instructions to:
request the one or more NAC link quality parameters for one or more candidate BSSs of the one or more NAC network devices;
compare the one or more NAC link quality parameters to a second link quality threshold, wherein the second link quality threshold is indicative of a NAC network performance associated with the one or more NAC network devices; and
wherein selecting the candidate BSS is based on the comparison of the one or more NAC link quality parameters to a second link quality threshold.

3. The access point device of claim 1, wherein the selecting the candidate BSS is based on one or more steering conditions.

4. The gateway device of claim 1, wherein the processor is further configured to execute the one or more computer-readable instructions to:
select another candidate BSS based on the response from the target client device, wherein the response indicates that the target client device did not steer to the candidate BSS;
send another steering query to the target client device to steer the target client device to the another candidate BSS, wherein the steering query indicates the another candidate BSS; and
receive another response from the target client device indicative of the steering to the another candidate BSS, wherein the another response indicates that the target client device accepted steering to the another candidate BSS.

5. The access point device of claim 4, wherein the candidate BSS is associated with a first band and the another candidate BSS is associated with a second band, wherein the first band and the second band are different.

6. The access point device of claim 1, wherein the processor is further configured to execute the one or more computer-readable instructions to:
determine that steering is enabled for the target client device based on a steering setting.

7. The access point device of claim 1, wherein the one or more NAC link quality parameters comprise at least one of a received signal strength indicator, a reference signal received power.

8. A method for steering a target client device from a current basic service set (BSS) to a candidate BSS, the method comprising:
determining a link quality issue associated with the target client device based on a comparison of one or more target link quality parameters to a first link quality threshold, wherein the first link quality threshold is indicative of a target network performance associated with the target client device;
determining that one or more non-associated client (NAC) link quality parameters are not available for one or more network devices;
selecting a candidate BSS of the one or more network devices for which the one or more NAC link quality parameters are not available; and
steering the target client device to the candidate BSS, wherein the steering comprises:
sending a steering query to the target client device to steer to the target client device to the candidate BSS, wherein the steering query indicates the candidate BSS; and
receiving a response from the target client device indicative of the steering to the candidate BSS.

9. The method of claim 8, further comprising:
requesting the one or more NAC link quality parameters for one or more candidate BSSs of the one or more NAC network devices.
comparing the one or more NAC link quality parameters to a second link quality threshold, wherein the second link quality threshold is indicative of a NAC network performance associated with the one or more NAC network devices; and
wherein selecting the candidate BSS is based on the comparison of the one or more NAC link quality parameters to a second link quality threshold.

10. The method of claim 8, wherein the selecting the candidate BSS is based on one or more steering conditions.

11. The method of claim 8, further comprising:
selecting another candidate BSS based on the response from the target client device, wherein the response indicates that the target client device did not steer to the candidate BSS;
sending another steering query to the target client device to steer the target client device to the another candidate BSS, wherein the steering query indicates the another candidate BSS; and
receiving another response from the target client device indicative of the steering to the another candidate BSS, wherein the another response indicates that the target client device accepted steering to the another candidate BSS.

12. The method of claim 11, wherein the candidate BSS is associated with a first band and the another candidate BSS is associated with a second band, wherein the first band and the second band are different.

13. The method of claim 8, further comprising:
determining that steering is enabled for the target client device based on a steering setting.

14. The method of claim 8, wherein the one or more NAC link quality parameters comprise at least one of a received signal strength indicator, and a reference signal received power.

15. A non-transitory computer-readable medium of an access point device storing one or more computer-readable instructions for steering a target client device from a current basic service set (BSS) to a candidate BSS, the one or more computer-readable instructions that when executed by a processor of the access point device cause the access point device to perform one or more operations comprising:
determining a link quality issue associated with the target client device based on a comparison of one or more target link quality parameters to a first link quality threshold, wherein the first link quality threshold is indicative of a target network performance associated with the target client device;
determining that one or more non-associated client (NAC) link quality parameters are not available for one or more network devices;
selecting a candidate BSS of the one or more network devices for which the one or more NAC link quality parameters are not available; and
steering the target client device to the candidate BSS, wherein the steering comprises:
sending a steering query to the target client device to steer to the target client device to the candidate BSS, wherein the steering query indicates the candidate BSS; and
receiving a response from the target client device indicative of the steering to the candidate BSS.

16. The non-transitory computer-readable medium of claim 15, wherein one or more further computer-readable instructions when executed by the processor cause the access point to perform one or more further operations comprising:
requesting the one or more NAC link quality parameters for one or more candidate BSSs of the one or more NAC network devices.
comparing the one or more NAC link quality parameters to a second link quality threshold, wherein the second link quality threshold is indicative of a NAC network performance associated with the one or more NAC network devices; and
wherein selecting the candidate BSS is based on the comparison of the one or more NAC link quality parameters to a second link quality threshold.

17. The non-transitory computer-readable medium of claim 15, wherein at least one of:
the selecting the candidate BSS is based on one or more steering conditions; and
the one or more NAC link quality parameters comprise at least one of a received signal strength indicator, and a reference signal received power.

18. The non-transitory computer-readable medium of claim 15, wherein one or more further computer-readable instructions when executed by the processor cause the access point to perform one or more further operations comprising:
selecting another candidate BSS based on the response from the target client device, wherein the response indicates that the target client device did not steer to the candidate BSS;
sending another steering query to the target client device to steer the target client device to the another candidate BSS, wherein the steering query indicates the another candidate BSS; and
receiving another response from the target client device indicative of the steering to the another candidate BSS, wherein the another response indicates that the target client device accepted steering to the another candidate BSS.

19. The non-transitory computer-readable medium of claim 18, wherein the candidate BSS is associated with a first band and the another candidate BSS is associated with a second band, wherein the first band and the second band are different.

20. The non-transitory computer-readable medium of claim 15, wherein one or more further computer-readable instructions when executed by the processor cause the access point to perform one or more further operations comprising:
determining that steering is enabled for the target client device based on a steering setting.
